(19) United States
(12) Patent Application Publication
(10) Pub. No.: US 2025/0328330 A1
(43) Pub. Date: Oct. 23, 2025

(54) RECOVERY OF UPDATE FAILURES IN LARGE DEPLOYMENTS

(71) Applicant: Dell Products L.P., Round Rock, TX (US)

(72) Inventors: Gokul Thiruchengode VAJRAVEL, Bangalore (IN); Shailesh Hastimal JAIN, Thane (IN); Ashish Rakesh SINGH, Mumbai (IN)

(73) Assignee: Dell Products L.P., Round Rock, TX (US)

(21) Appl. No.: 18/642,352

(22) Filed: Apr. 22, 2024

(51) Int. Cl. G06F 8/61

(52) U.S. Cl. CPC G06F 8/62

(57) ABSTRACT

An information handling system may include at least one processor and a memory. The information handling system may be configured to provide update management services for a group of managed information handling systems by: transmitting instructions to the group to deploy a first update policy, wherein the first update policy includes installation of a selected version of a selected application; determining that the selected version of the selected application is corrupt and/or subject to a known vulnerability; and transmitting instructions to the group to deploy a second update policy, wherein the second update policy includes: installation of a newer version of the selected application in response to a determination that the newer version is available; and uninstallation of the selected version of the selected application in response to a determination that the newer version is not available.

### TECHNICAL FIELD

The present disclosure relates in general to information handling systems, and more particularly to providing updates for software and/or firmware to large deployments of information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Hyper-converged infrastructure (HCI) is an IT framework that combines storage, computing, and networking into a single system in an effort to reduce data center complexity and increase scalability. Hyper-converged platforms may include a hypervisor for virtualized computing, software-defined storage, and virtualized networking, and they typically run on standard, off-the-shelf servers. One type of HCI solution is the Dell EMC VxRail™ system. Some examples of HCI systems may operate in various environments (e. g., an HCI management system such as the VMware® vSphere® ESXi™ environment, or any other HCI management system). Some examples of HCI systems may operate as software-defined storage (SDS) cluster systems (e.g., an SDS cluster system such as the VMware® vSAN™ system, or any other SDS cluster system).

In the HCI context (as well as other contexts), information handling systems may execute virtual machines (VMs) for various purposes. A VM may generally comprise any program of executable instructions, or aggregation of programs of executable instructions, configured to execute a guest operating system on a hypervisor or host operating system in order to act through or in connection with the hypervisor/host operating system to manage and/or control the allocation and usage of hardware resources such as memory, central processing unit time, disk space, and input and output devices, and provide an interface between such hardware resources and application programs hosted by the guest operating system.

In both HCI and non-HCI contexts, information handling systems may need to install updates from time to time. In large deployments of information handling systems, the process of pushing out such updates may take a significant amount of time. In the event of a problem with an update (e. g., a corrupted or vulnerable update being pushed out), existing solutions for remediation are not optimal. Embodiments of this disclosure thus address these and similar issues.

It should be noted that the discussion of a technique in the Background section of this disclosure does not constitute an admission of: prior-art status. No such admissions are made herein, unless clearly and unambiguously identified as such.

### SUMMARY

In accordance with the teachings of the present disclosure, the disadvantages and problems associated with updating information handling systems may be reduced or eliminated.

In accordance with embodiments of the present disclosure, an information handling system may include at least one processor and a memory. The information handling system may be configured to provide update management services for a group of managed information handling systems by: transmitting instructions to the group to deploy a first update policy, wherein the first update policy includes installation of a selected version of a selected application; determining that the selected version of the selected application is corrupt and/or subject to a known vulnerability; and transmitting instructions to the group to deploy a second update policy, wherein the second update policy includes: installation of a newer version of the selected application in response to a determination that the newer version is available; and uninstallation of the selected version of the selected application in response to a determination that the newer version is not available.

In accordance with these and other embodiments of the present disclosure, a method for providing update management services for a group of managed information handling systems may include: an information handling system transmitting instructions to the group to deploy a first update policy, wherein the first update policy includes installation of a selected version of a selected application; the information handling system determining that the selected version of the selected application is corrupt and/or subject to a known vulnerability; and the information handling system transmitting instructions to the group to deploy a second update policy, wherein the second update policy includes: installation of a newer version of the selected application in response to a determination that the newer version is available; and uninstallation of the selected version of the selected application in response to a determination that the newer version is not available.

In accordance with these and other embodiments of the present disclosure, an article of manufacture may include a computer-readable medium having computer-non-transitory, executable instructions thereon that are executable by a an information processor of handling system for: transmitting instructions to a group of managed information handling systems to deploy a first update policy, wherein the first update policy includes installation of a selected version of a selected application; determining that the selected version of the selected application is corrupt and/or subject to a known vulnerability; and transmitting instructions to the group to deploy a second update policy, wherein the second update policy includes: installation of a newer version of the selected application in response to a determination that the newer version is available; and uninstallation of the selected version of the selected application in response to a determination that the newer version is not available.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a system architecture diagram, in accordance with embodiments of the present disclosure;

FIGS. 3-4 illustrate example methods, in accordance with embodiments of the present disclosure; and

FIGS. 5-6 illustrate system architecture diagrams, in accordance with embodiments of the present disclosure.

### DETAILED DESCRIPTION

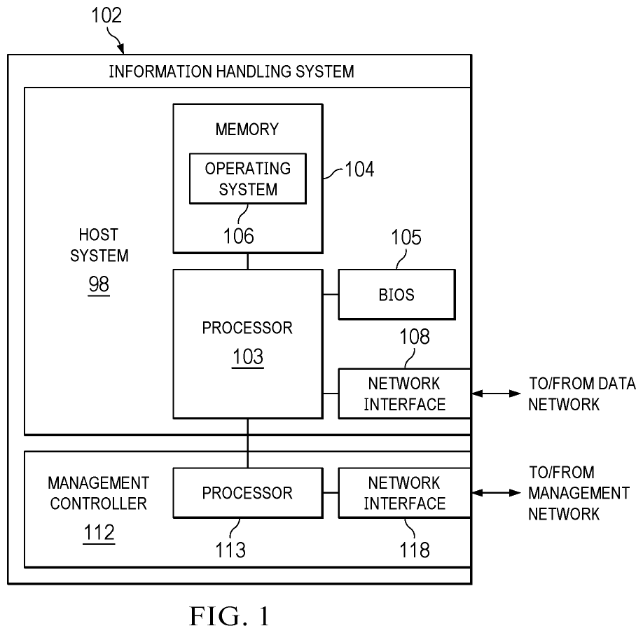

Preferred embodiments and their advantages are best understood by reference to FIGS. 1 through 6, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using asny suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

Information handling system 102 may be an element of a large deployment of information handling systems (e.g., a multi-tenant cloud environment. It may be necessary from time to time to apply updates to information handling system 102 and its peers.

Information handling systems 102 may be deployed in groups and subgroups (e.g., based on geography). For example, one group may cover North America, another group may cover Asia, etc. For large groups, applying an update may take a week or even longer.

Updates may be organized in update bundles. An update bundle may include one or more packages of applications, operating system updates, firmware updates, etc. When an update bundle is pushed to a large number of devices across different groups, there is a possibility that one or more packages in the bundle is in a corrupted or vulnerable state. There is also a possibility that the update may be incompatible with some portion of the group, since the information handling systems in a group are typically not all identical. Currently in such a situation, a manual rollback needs to be done, which is time-consuming and cumbersome.

Embodiments of this disclosure thus address solutions for these and other problems related to large-scale updates.

For example, an administrator may push out an update policy that contains a corrupted application. After some information handling systems have begun installing the update, the administrator realizes the issue and wants to roll back the application update, but would prefer to allow the rest of the policy to continue to apply. For example, the update policy might contain a variety of items, such as a multi-monitor configuration setting, an Active Directory join policy, and three applications; however, Application 1 turns out to be corrupted. The administrator may then want the endpoints to proceed with all of the policy update except the installation of Application 1.

As another example, an administrator may push out an update policy that contains a vulnerable application. The administrator may want to push the next higher available version of that application, but without needing to roll back the rest of the policy. For example, if the flawed update policy specified version 5.0 of the application, the administrator might want to cause all of the endpoints that have already installed 5.0 to update to 5.1, and all of the endpoints that have not yet installed 5.0 to jump directly to 5.1.

In existing solutions, it may be difficult to manually identify the corrupted/vulnerable application, re-create the update policy to address the issue, and re-deploy the update policy to the group. Doing so will typically also cause the devices in the group to go through multiple update cycles.

Thus it would be desirable for an administrator to have an automated way of correcting corrupted or vulnerable applications in a group policy update and notifying endpoints to ignore only the problematic applications, while applying the rest of the policy (rather than rolling back or stopping the entire policy).

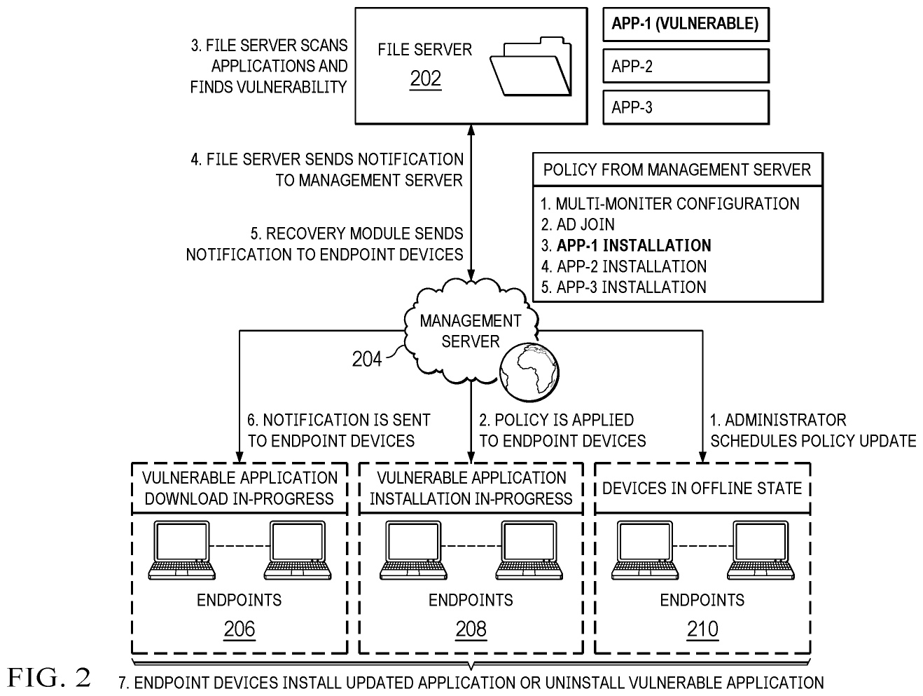

FIG. 2 provides a high-level architecture diagram of one embodiment. The embodiment of FIG. 2 may include the following high-level components.

File server 202, which may host the files associated with update bundles, may include:
a notification service, which identifies corrupted or vulnerable applications and sends notifications to management server 204 as soon as a problem is detected. Management server 204 may include:
an application protection and control policy service, which takes actions based on notifications received for corrupted or vulnerable applications, checks group policy for the presence of such applications, and checks whether affected applications are installed on each group and subgroup, processing recovery actions accordingly;
a recovery module, which takes a package list (in-progress and already installed) to check updates, notifies endpoints 206 to skip or avoid the installation of an application, applicable to devices where an application installation is in-progress or has not been installed yet; and
a deploy policy module, which performs scheduling of application policies, schedules the latest application package installations for which updated versions are available, and schedules uninstallation of application package for which no updated versions are available.

Endpoint devices 206, 208, and 210 may include:
a client agent notification service, which handles notifications for vulnerable or corrupted applications and skips in-progress applications during download or installation. It may take actions on notification package lists received from management server 204, updating entries in a pending package list database (e.g., stored on the endpoint device), which is then read by the client agent application policy service for processing the application policy. When a notification is received for a corrupted or vulnerable application package, this service may update the pending package list database by removing the application package entry if it is already available, or adding an “avoid package” entry if there is no existing entry available for the package;
a client agent application policy service, which processes package installation and uninstallation by reading from the pending package list database; and. a platform package manager, which processes the installation and uninstallation operations on the device.

At step 1, an administrator may schedule a policy update for configuration and/or application installation for one or more groups of endpoint devices. As in one of the example scenarios above, the policy includes a multi-monitor configuration setting, an Active Directory join policy, and three applications; however, Application 1 turns out to be corrupted or vulnerable. The policy update may be initiated via management server 204 in some embodiments.

At step 2, the policy begins to be applied to the registered endpoint devices within each group.

At step 3, file server 202 scans each application and finds a vulnerability in Application 1.

At step 4, file server 202 sends a notification to management server 204 regarding the vulnerable application. po At step 5, the recovery module of management server 204 sends notifications to the endpoint devices to skip installation of application 1 if it is not already installed. It also schedules an application installation policy for the latest version of application 1, if available. Otherwise, it may schedule an application uninstallation policy using the deploy policy module.

At step 6, the endpoint devices receive the notification. As shown, the endpoints devices include three groups. Endpoints 206 are currently downloading a vulnerable application. Endpoints 208 are currently installing a vulnerable application. And endpoints 210 are currently offline. When endpoints 206 receive a notification as shown, they may delete the vulnerable application's name from the pending package list database and automatically skip its installation. When endpoints 208 receive the notification, they may either skip the installation (if it has not yet begun), cancel the installation in progress if possible, or ignore the notification if installation cannot be stopped. Endpoints 210 cannot process the notification until they become online again.

At step 7, the endpoint devices receive the install/uninstall application policy from the recovery module on management server 204. These policies may cause the endpoint devices to replace the vulnerable application by installing an updated version. If no updated version is available, the policies may cause the endpoint devices to uninstall the vulnerable application.

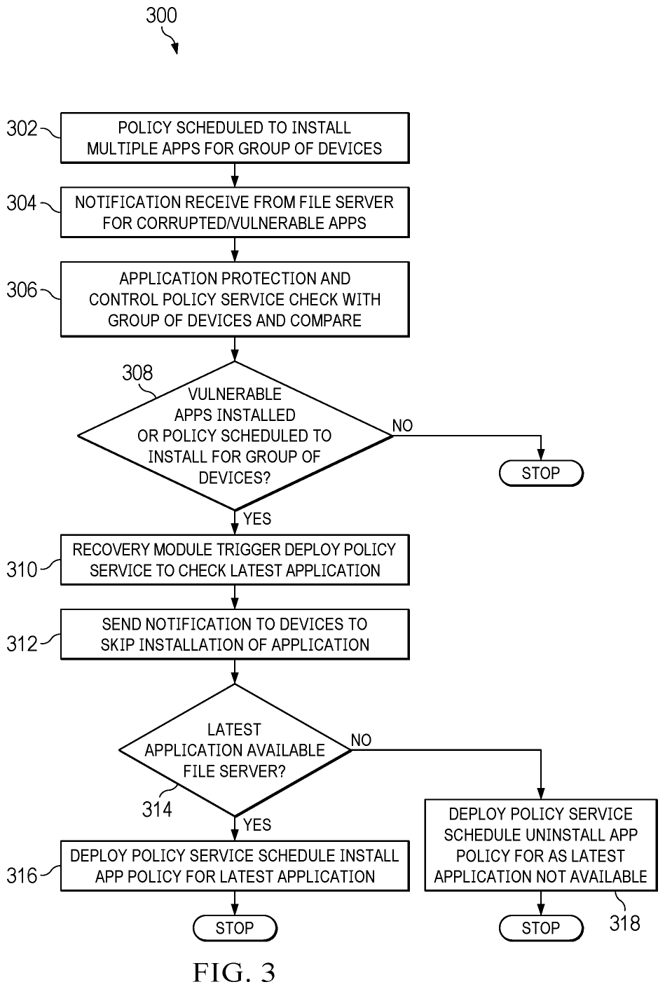

Turning now to FIG. 3, an example method 300 is shown for operation of a file server and a management server, in accordance with some embodiments. At step 302, a policy update is scheduled on the management server to install multiple applications for some device group.

At step 304, the management server receives a notification from the file server regarding one or more corrupt or vulnerable applications.

At steps 306 and 308, the management server's application protection and control policy service checks with the group of endpoint devices and compares their installed and scheduled applications against the notice. If any vulnerable applications are installed or scheduled to be installed, the method proceeds to step 310. If not, the method ends.

At step 310, the recovery module of the management server causes the deploy policy module to check for the latest version of the application. At step 312, the management server sends a notification to the endpoint devices to skip installation of the vulnerable application.

If an updated version of the application is available on the file server at step 314, then at step 316, the updated application is scheduled for installation. If not, then at step 318, the vulnerable application is scheduled for uninstallation and the method ends.

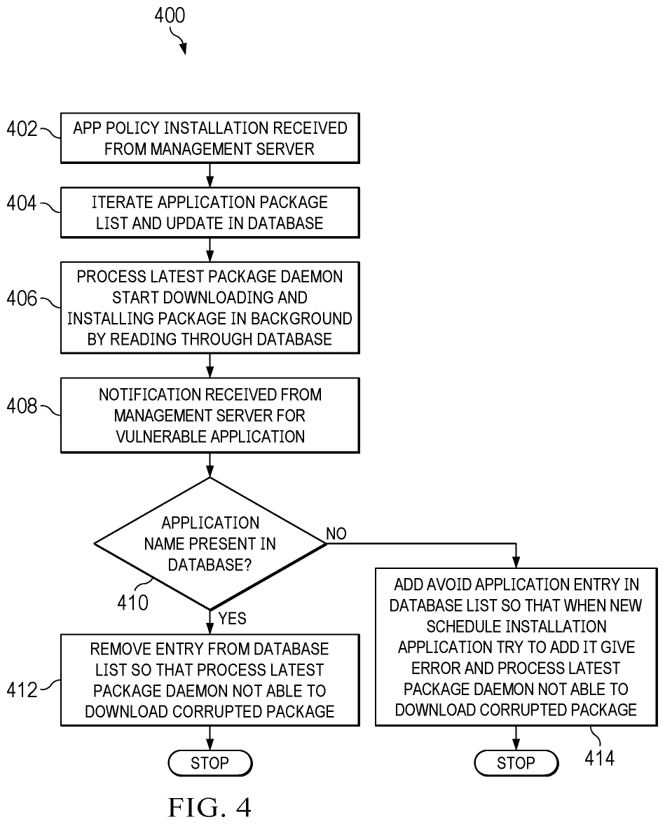

Turning now to FIG. 4, an example method 400 is shown for operation of an endpoint device, in accordance with some embodiments. At step 402, an application policy is received from the management server. At step 404, the endpoint device iterates through the application package list and updates the pending package list database accordingly.

At step 406, a daemon or other service for processing the latest package list begins downloading and installing packages in the background in accordance with the pending package list database.

At step 408, a notification is received from the management server regarding a vulnerable application. If that application name is present in the database at step 410, then at step 412, it is removed from the database to prevent the daemon from downloading and installing it. If not, then at step 414, an entry is made in the database to avoid that application, so that if someone tries to install it in the future, the installation will fail.

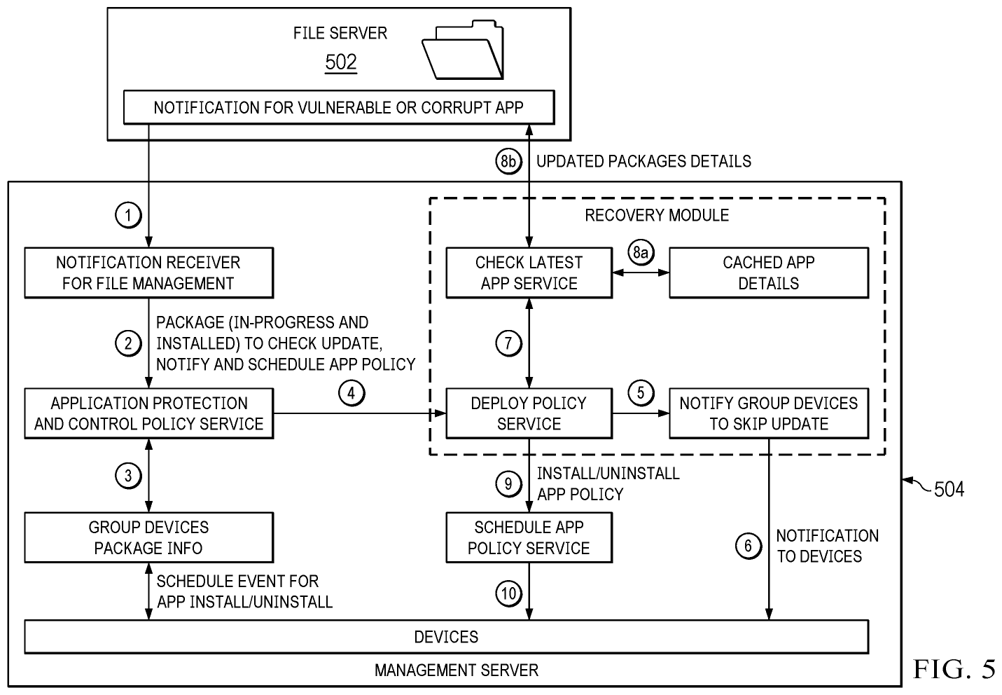

One of ordinary skill in the art with the benefit of this disclosure will understand that the preferred initialization point for the methods depicted in FIGS. 3 and 4 and the order of the steps comprising those methods may depend on the implementation chosen. In these and other embodiments, these methods may be implemented as hardware, firmware, software, applications, functions, libraries, or other instructions. Further, although FIGS. 3 and 4 disclose a particular of steps to be taken with respect to the disclosed methods, the methods may be executed with greater or fewer steps than depicted. The methods may be implemented using any of the various components disclosed herein (such as the components of FIG. 1), and/or any other system operable to implement the methods. FIG. 5 shows an architecture view of various components of file server 502 and management server 504, according to some embodiments. The details of how these components operate may be similar or identical to the discussion above.

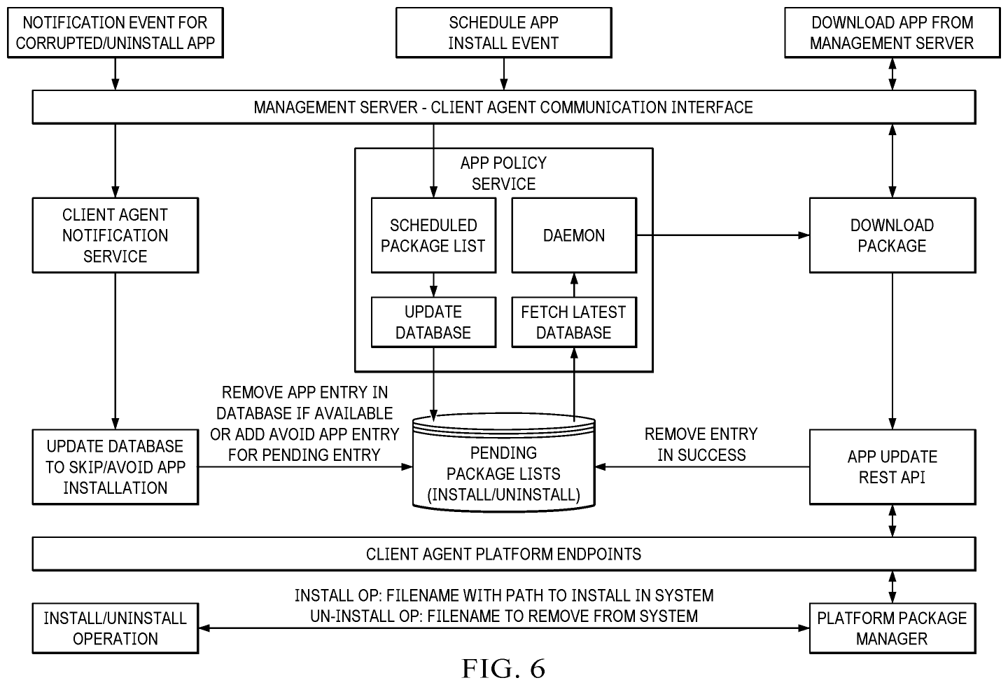

FIG. 6 shows an architecture view of the components of an endpoint device 606, according to some embodiments. The details of how these components operate may be similar or identical to the discussion above.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor; and
a memory;
wherein the information handling system is configured to provide update management services for a group of managed information handling systems by:
transmitting instructions to the group to deploy a first update policy, wherein the first update policy includes installation of a selected version of a selected application;
determining that the selected version of the selected application is corrupt and/or subject to a known vulnerability; and
transmitting instructions to the group to deploy a second update policy, wherein the second update policy includes:
installation of a newer version of the selected application in response to a determination that the newer version is available; and
uninstallation of the selected version of the selected application in response to a determination that the newer version is not available.

2. The information handling system of claim 1, wherein the information handling system is an element of a hyper-converged infrastructure (HCI) system.

3. The information handling system of claim 1, wherein the group of managed information handling systems is distributed across multiple datacenters in a selected geographic region.

4. The information handling system of claim 1, wherein the first update policy includes installation of at least one other component, and wherein the installation of the at least one other component is not affected by the second update policy.

5. The information handling system of claim 1, wherein the instructions to deploy the second update policy are transmitted without intervention by a human administrator.

6. The information handling system of claim 1, wherein the information handling system is a management server, and wherein the determination that the selected version of the selected application is corrupt and/or subject to a known vulnerability is based on a notification received from a file server.

7. A method for providing update management services for a group of managed information handling systems comprising:
an information handling system transmitting instructions to the group to deploy a first update policy, wherein the first update policy includes installation of a selected version of a selected application;
the information handling system determining that the selected version of the selected application is corrupt and/or subject to a known vulnerability; and
the information handling system transmitting instructions to the group to deploy a second update policy, wherein the second update policy includes:
installation of a newer version of the selected application in response to a determination that the newer version is available; and
uninstallation of the selected version of the selected application in response to a determination that the newer version is not available.

8. The method of claim 7, wherein the information handling system is an element of a hyper-converged infrastructure (HCI) system.

9. The method of claim 7, wherein the group of managed information handling systems is distributed across multiple datacenters in a selected geographic region.

10. The method of claim 7, wherein the first update policy includes installation of at least one other component, and wherein the installation of the at least one other component is not affected by the second update policy.

11. The method of claim 7, wherein the instructions to deploy the second update policy are transmitted without intervention by a human administrator.

12. The method of claim 7, wherein the information handling system is a management server, and wherein the determination that the selected version of the selected application is corrupt and/or subject to a known vulnerability is based on a notification received from a file server.

13. An article of manufacture comprising a non-transitory, computer-readable medium having computer-executable instructions thereon that are executable by a processor of an information handling system for:
transmitting instructions to a group of managed information handling systems to deploy a first update policy, wherein the first update policy includes installation of a selected version of a selected application;
determining that the selected version of the selected application is corrupt and/or subject to a known vulnerability; and
transmitting instructions to the group to deploy a second update policy, wherein the second update policy includes:
installation of a newer version of the selected application in response to a determination that the newer version is available; and
uninstallation of the selected version of the selected application in response to a determination that the newer version is not available.

14. The article of claim 13, wherein the information handling system is an element of a hyper-converged infrastructure (HCI) system.

15. The article of claim 13, wherein the group of managed information handling systems is distributed across multiple datacenters in a selected geographic region.

16. The article of claim 13, wherein the first update policy includes installation of at least one other component, and wherein the installation of the at least one other component is not affected by the second update policy.

17. The article of claim 13, wherein the instructions to deploy the second update policy are transmitted without intervention by a human administrator.

18. The article of claim 13, wherein the information handling system is a management server, and wherein the determination that the selected version of the selected application is corrupt and/or subject to a known vulnerability is based on a notification received from a file server.
